(19) United States
(12) Patent Application Publication
(10) Pub. No.: US 2024/0302492 A1
(43) Pub. Date: Sep. 12, 2024

(54) MACHINE LEARNING SYSTEM FOR IDENTIFYING AND COUNTERING NON-FRIENDLY RADAR NETWORKS

(71) Applicant: Andro Computational Solutions, LLC, Rome, NY (US)

(72) Inventors: Jithin Jagannath, Oriskany, NY (US); Nicholas Joseph Polosky, Niskayuna, NY (US); Andrew Louis Drozd, Rome, NY (US); Sean Furman, Sherrill, NY (US); Tyler Gwin, Esperance, NY (US)

(21) Appl. No.: 18/596,893

(22) Filed: Mar. 6, 2024

Related U.S. Application Data
(60) Provisional application No. 63/488,571, filed on Mar. 6, 2023.

(51) Int. Cl. G01S 7/38; G01S 7/02

(52) U.S. Cl. CPC G01S 7/38; G01S 7/021

(57) ABSTRACT

Embodiments of the disclosure provide a machine learning system for identifying and countering non-friendly radar networks. Methods of the disclosure include generating, in a machine learning module, an operational model of a radar network within an environment. An autonomous agent within the environment detects the radar network. The method also includes classifying the radar network as friendly or non-friendly based on the operational model. The method also includes generating, in a reinforcement learning module, a counter-radar maneuver based on the operational model in response to classifying the radar network as non-friendly. Embodiments of the disclosure implement the counter-radar maneuver via the autonomous agent in communication with the reinforcement learning module.

### BACKGROUND

The present disclosure relates to various operations conducted in radar networks, and in particular, to the functionality and adaptability of autonomous agents deployed in such environments.

As near-peer radar technology advances, tactics for counteracting adversary radars and radar networks need to evolve as well. In the realm of software defined radio (SDR) and agile waveform development, highly adaptive radar networks are common and traditional, pre-determined or prescribed electronic warfare (EW) countermeasures used against conventional radar networks may be insufficient. Although autonomous agents (e.g., unmanned vehicles such as Unmanned Aerial Vehicles (UAVs), or similar vehicles subject to a remote operator) may have the ability to sense and communicate weaknesses in advanced, agile radar networks, taking advantage of these capabilities presents unique difficulties. For instance, the autonomous agent(s) must be interoperable with other manned and unmanned members of any hardware for counteracting an adversary's network(s). Moreover, autonomous agents demand precise trajectory computation and execution when deployed, as many radar defeat strategies involve coordinated maneuvers that are directionally dependent and time critical.

Conventional radar negation techniques for autonomous agents generally use frameworks of preplanned negation maneuvers, drawn from two main styles of negation: phantom track generation and jamming. In phantom track generation strategies, a team of agents may compute a coordinated maneuver while repeating received radar signals to induce a false detection at the transmitting radars. The false detection usually portrays the detection of a single vehicle at a distance between that of this anti-radar team and the maximum range of the emitting radars. In jamming strategies, a single agent or group of agents emits noise signals to disrupt the targeted radar's return signal, corrupting the tracking mechanisms within the afflicted radar. These types of techniques can be further coordinated to produce constructive/destructive interferences to amplify or conceal the jamming signals.

In conventional systems, one or more of the “phantom track” or “false detection” techniques can be used to generate predetermined “plays” for different operational scenarios. The above-noted techniques can be incorporated into a single play for multiple agents, e.g., an anti-radar UAV swarm. In a conventional anti-radar operation, autonomous agents in an operational environment can monitor and interpret certain characteristics of the enemy radar network via sensing, and a determinative framework then selects a preplanned defeat mechanism for the team to perform. Although straightforward, this approach is insufficient for negating radar networks with agile waveforms and sensing capabilities. That is, conventional techniques cannot account for countermeasures implemented in the target radar system.

### SUMMARY

The illustrative aspects of the present disclosure are designed to solve the problems herein described and/or other problems not discussed.

Aspects of the disclosure provide a method including: generating, in a machine learning module, an operational model of a radar network within an environment, wherein an autonomous agent within the environment detects the radar network; classifying the radar network as friendly or non-friendly based on the operational model; generating, in a reinforcement learning module, a counter-radar maneuver based on the operational model in response to classifying the radar network as non-friendly; and implementing the counter-radar maneuver via the autonomous agent in communication with the reinforcement learning module.

Further aspects of the disclosure provide a system including: a machine learning module configured to: generate an operational model of a detected radar network within an environment, and classify the radar network as friendly or non-friendly based on the operational model; a reinforcement learning module in communication with the machine learning module and configured to generate a counter-radar maneuver based on the operational model in response to classifying the radar network as non-friendly; and an autonomous agent in communication with the reinforcement learning module and configured to implement the counter-radar maneuver.

Additional aspects of the disclosure provide a computer program product for control of an autonomous agent, the computer program product including a computer readable storage medium with program code for causing a computer system to perform actions including: generating, in a machine learning module, an operational model of a radar network within an environment, wherein the autonomous agent detects the radar network; classifying the radar network as friendly or non-friendly based on the operational model; generating, in a reinforcement learning module, a counter-radar maneuver based on the operational model in response to classifying the radar network as non-friendly; and implementing the counter-radar maneuver via the autonomous agent in communication with the reinforcement learning module.

### BRIEF DESCRIPTION OF THE DRAWINGS

FIG. 1 shows a schematic diagram of autonomous agents interacting with a reinforcement learning module to identify and counter non-friendly radar networks according to embodiments of the disclosure.

FIG. 2 shows a schematic view of a machine learning framework for generating an operational model of a radar network according to embodiments of the disclosure.

FIG. 3 provides a schematic diagram of an illustrative environment for identifying and countering non-friendly radar networks according to embodiments of the disclosure.

FIG. 4 provides a schematic diagram of a machine learning module for identifying non-friendly radar networks according to embodiments of the disclosure.

FIGS. 5-7 provide illustrative flow diagrams with operational methodologies in various embodiments of the disclosure.

### DETAILED DESCRIPTION

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described to best explain the principles of the disclosure and the practical application, and to enable others of ordinary skill in the art to understand the disclosure for various embodiments with various modifications as are suited to the particular use contemplated.

Embodiments of the disclosure provide a machine learning system for identifying and countering non-friendly radar networks. Methods of the disclosure include generating, in a machine learning module, an operational model of a radar network within an environment. An autonomous agent within the environment detects the radar network. The method also includes classifying the radar network as friendly or non-friendly based on the operational model, e.g., by using one or more artificial neural networks (ANNs). The method also includes generating, in a reinforcement learning module, a counter-radar maneuver based on the operational model in response to classifying the radar network as non-friendly. Embodiments of the disclosure implement the counter-radar maneuver via the autonomous agent in communication with the reinforcement learning module.

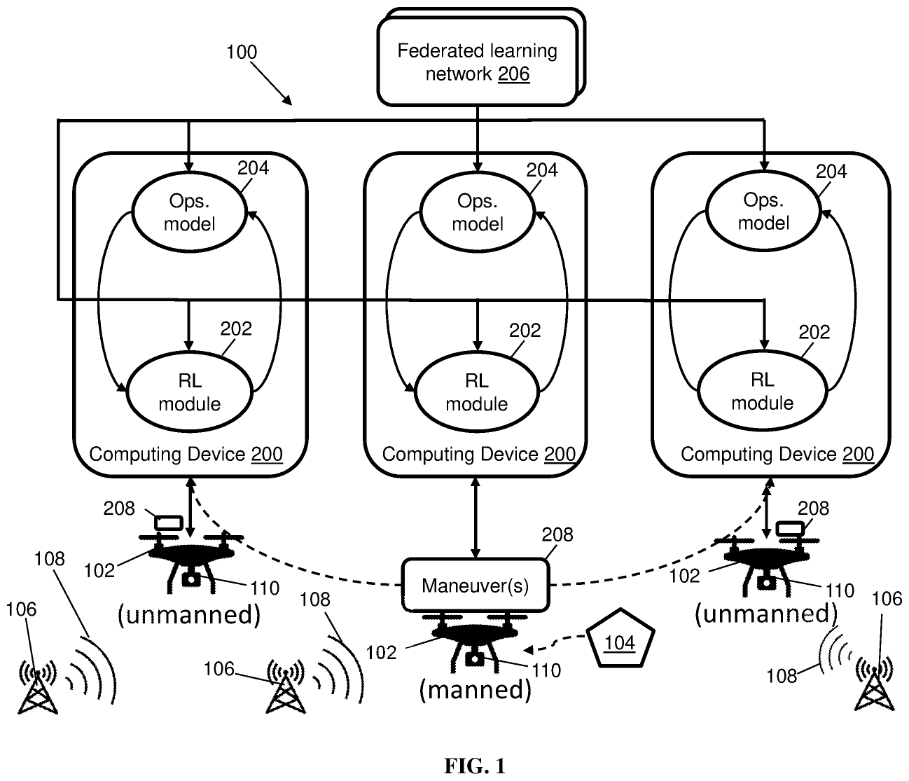

Referring to FIG. 1, a schematic diagram of an environment 100 with several autonomous agents 102 interacting with reinforcement learning modules 202 is shown. According to an example, environment 100 may implement machine learning system features suitable for groups of autonomous agents 102 operating within environment 100. Autonomous agents 102 may be deployed as a manned-unmanned team (MUM-T), e.g., in a setting where some agents 102 operate fully autonomously (“unmanned”) and other agents 102 operate partially autonomously (i.e., partially based on inputs from human users 104—“manned”). Whether manned or unmanned, agents 102 may not include a human user directly piloting or operating agent(s) 102, or otherwise present within environment 100. In such settings, agents 102 may be operating within known and/or unknown radar networks. An emitter 106 (e.g., a base station, autonomous agent from another team, and/or any other device for emitting detectable signals 108) within a radar network may transmit signals 108 that may be detected with sensors 110 (e.g., cameras, microphones, antennae, or other receivers) of each autonomous agent 102. Whether known or unknown, such radar networks and emitters 106 thereof may be friendly or non-friendly. Embodiments of the disclosure allow MUM-T groups of autonomous agents 102, along with systems and subcomponents in communication therewith, to identify and counteract non-friendly radar networks. Embodiments of the disclosure may be particularly effective for operations involving autonomous agents 102 in the form of unmanned air vehicles (UAVs) capable of sensing and communicating weaknesses in a radar network and/or emitters 106 back to other autonomous agent(s) 102 and/or other, e.g., other autonomous agents 102 or human users 104 operating and/or administering the system.

Systems according to the disclosure may be implemented on multiple autonomous agents (alternatively “agents” hereafter) 102 I (e.g., a UAV swarm) in which each agent 102 senses various attributes of radar networks therein and uses an operational model 202 of emitters 106 and signals 108 in environment 100 to characterize a particular radar network as friendly or non-friendly. In the case of a non-friendly radar network, agents 102 will identify or predict enemy radar weaknesses, generate counter-radar maneuvers in reinforcement learning modules 202, and may communicate these weaknesses to other agents 102 (and/or different types of devices, users, etc.) within the team. During operation, one or more computing devices 200 implemented on, or otherwise in communication with, each autonomous agent 102 may implement various machine learning techniques to generate an operational model 204 of the radar network and predict operational scenarios within that network. This approach, unlike conventional systems, does not use predetermined “plays” of radar negation strategies for operations in non-friendly radar networks. Among other advantages, embodiments of the disclosure enable continuous training and re-use of agents 102 across differing mission scenarios. Further, machine learning allows teams of agents 102 to adapt their negation strategies within a single mission. Thus, as non-friendly radar networks modify their response strategy within the span of a particular operation, agent(s) 102 via machine learning can make corresponding changes to secure operationally advantageous positions in environment 100. In turn, these benefits reduce the risk of harm to, or loss of, agent(s) 102.

Various systems and methods according to the disclosure enable agents 102 to modify and update actions, as well as their underlying throughout a mission, based on the sensed dynamic characteristics of radar networks and/or emitters 106 therein (e.g., friendly or non-friendly radar networks) within environment(s) 100 where they operate. More specifically, the systems and methods herein implement various machine learning features (e.g., reinforcement learning combined with other machine learning techniques, e.g., federated learning) to increase the survivability and effectiveness of agents 102. Systems and methods of the disclosure thus combine the advantages of machine learning based signal intelligence and other techniques (e.g., federated reinforcement learning) to overcome challenges of conventional swarm-based radar negation.

Unlike conventional techniques, various embodiments of the disclosure may use modular software subsystems (i.e., multiple machine learning techniques, individually or in combination) to enhance coordinated radar negation in environments 100 with multiple types of agents 102, e.g., using multi-task learning signal intelligence techniques. Such techniques use information collected from multiple agents 102 within environment 100 and/or other sources (e.g., libraries of data, inputs from human users 104, etc.) to generate an operational model 204 of radar networks having emitters 106 thereof within environment. The operational model(s) 204 can be shared between agents 102 as well as other entities (e.g., a radar negation team). The information collected in agent(s) 102 (e.g., via sensor(s) 110) to generate operational model 204 may include, e.g., radio frequency (RF) sensing of emitters 106 and/or signals 108 in a targeted radar network in environment 100, and machine learning-assisted signal classification to classify a targeted network as friendly or non-friendly. Within these categories, the RF network(s) may be given more specific classifications (e.g., hostile, friendly, neutral, and/or any other appropriate classification).

Systems and methods of the disclosure enable agents 102 to counteract non-friendly radar networks by applying distributed reinforcement learning techniques (e.g., federated learning) with operational models 204 of the radar networks to craft novel defeat approaches. Such techniques do not necessarily reflect the phantom track or jamming strategies for counteracting enemy radar in non-friendly networks. Each computing device 200 may include a reinforcement learning module (“RL module”) 202 together with an operational model (“Ops. model”) 204 for a particular radar network. Reinforcement learning modules 202, together, may be included within and/or may define a federated learning network 206 for environment 100. The anti-radar team of agents 102 and/or users 104 thereof thus may use reinforcement learning module(s) 202 and operational model(s) 204 together to develop one or more counter-radar maneuvers (“maneuvers”) 208. Maneuvers 208 are not necessarily limited to physical movements and actions within environment 100 as they may include, e.g., intercommunications with other agents 102, signal construction techniques for counteracting a wide variety of radars, and/or further analysis to evaluate the effectiveness of counteracting certain emitter(s) 106 and/or signals 108.

Federated learning network 206 for interlinking multiple agents 102 allows continuous updates in behavior for each agent 102 to counteract any corresponding behavioral and/or operational changes within environment 100. Each agent 102 in environment 100 can initiate updates in each other by communicating their local policy updates to operational model(s) 204. Embodiments of the disclosure are scalable across multiple types of agents 102 (including different types of vehicles, devices, software platforms, etc.) for interoperation between diverse sets of agents 102. Further, the systems and methodologies herein allow intra-team communication by sharing information between each agent 102 while also being persistent in future operational settings where the team of agents 102 and/or the environment 100 of operation changes.

In some embodiments, the systems according to the disclosure may be implemented using a modular open systems approach, in which various maneuvers 208 can be added to or deleted from a library for each agent 102 over time. Modular open systems approach based implementations may continuously integrate information measured via sensors 110 (e.g., additional signals 108 and/or additional emitters 106) into the machine learning data for RL modules 202 and/or operational models 204. Further, modular open systems approach based implementations allow the methodology discussed to be implemented on a wide variety of platforms (and thus a variety of agents 102) and/or configured for each individual software platform in the case where similar or identical agents 102 implement different types of software and/or versions of the same software.

During operation, RL module(s) 202 and operational model(s) 204 cooperate to continuously generate and/or remove maneuvers 208 to be implemented with each agent 102. Each operational model 204 functions by modeling a particular radar network (e.g., using signals 108 and information about emitters 106) by isolating and identifying signals 108. Each operational model 204 allows a particular agent to classify a particular radar network as friendly or non-friendly and may be shared with other agents 102 to allow remote updating of other operational models 204. This updating may include, e.g., providing operational model 204 or some aspects thereof, as well as any new and/or updated objectives submitted to agent(s) 102, as a machine learning input to other agents 102, thus training operational models 204 for other agents 102. By reference to the classification of a radar network, RL modules 202 individually or collectively as part of federated learning network 206 may generate, modify, add, and/or remove maneuvers 208 to be implemented in each agent 102 operating within environment 100. RL modules 202 may function continuously, thereby allowing maneuvers 208 to change throughout each operation to be implemented by agent(s) 102 within environment 100. RL modules 202 and operational models 204 may work with other tools on agent(s) 102 for characterizing and/or counteracting radar networks, including machine-learning based or non-machine learning based radar negation tools, e.g., to update other radar negation tools and/or provide outputs other than maneuvers 208 to such tools.

Operational model(s) 204 may receive various types of data regarding emitter(s) 106 and/or signal(s) 108 in environment 100 to detect radar networks and classify them as friendly or non-friendly. Upon detecting a non-friendly radar network via emitter(s) 106 and/or signal(s) 108, computing device 200 also may use operational model 204 to determine the threat level of such a network. Operational model 204 may implement (or otherwise include) a blind signal separation (BSS) component to accurately characterize aspects of signals 108 environment 100. BSS components operate by separating signal(s) 108 under analysis from other signals 108 and/or noise that is also detected in sensor(s) 110. BSS components of operational model 204 of computing device 200 may implement a generalized eigenvalue decomposition method which decomposes all signals 108 detected in sensor 110 from a linear mixture and recovers the separated sources. BSS components of operational model 204 then generate a mixing matrix to represent how each emitter 106 and the environmental noise (all detected via sensor(s) 110) produce the overall received signal. This method is advantageous for environments 100 with many emitters 106 and signals 108 for not requiring any existing knowledge or data about the signals or their mixture, i.e., it is suitable for dynamically changing environments. With the estimated mixing matrix, the original signals are recovered and computing device 200 provides those signals to a signal identification component of operational model 204.

After independent signals are extracted (e.g., via BSS of operational model 204), a signal identification component of operational model 204 estimates one or more signal descriptors using machine learning from individual source emitters 106. A multi-task learning framework may be implemented within operational model 204 to estimate descriptors such as, e.g., bandwidth, modulation, pulse width discriminator (PWD), pulse repetition interval (PRI), etc., thereby generating a signal profile for each signal present in the environment. Multi-task learning (MTL) is a machine learning technique in which multiple learning tasks are solved simultaneously while relying upon commonalities or differences in solving the multiple tasks. A multi-task learning framework is particularly effective due to its inherent ability to generalize better than individual task models. It has been determined that multi-task signal descriptor prediction of signal 108 properties via multi-task learning allows further customization to identify unique characteristics of a signal observed by agents 102 in challenging channel situations, e.g., environments 100 with a large number of signals 108 present from varying types of emitters 106.

Operational model(s) 204 additionally or alternatively can associate any isolated signals with specific emitters 106 in environment 100. In some cases, using signal descriptors previously ascertained in operational model 204 is not a viable solution as each set of signal descriptors may be produced by one or more individual emitters 106, and each emitter 106 may produce multiple signal descriptor profiles in operational model(s) 204. Accordingly, operational model(s) 204 of computing device(s) 200 may also extract unique transmission characteristics (e.g., unique hardware/software differences, manufacturing inaccuracies, etc.) from emitter(s) 106 to identify specific emitters 106 with consistency, based on the unique transmission characteristics. Such an approach, and the requisite hardware or software components for implementing it, are optional features that may be included only in some implementations of operational model 204. In such cases, these features and their subcomponents are known as Specific Emitter Identification (SEI), or “RF fingerprinting.”

Operational model(s) 204 may combine analytic signal extraction methods and machine learning to provide this functionality. Higher order signal analysis methods employing the bispectrum of the received signal may be well suited for feature extraction, as these methods inherently eliminate the role of Gaussian noise in each feature and can be extended using empirical mode decomposition and the bispectrum radon transform to obtain features which have been successful in SEI tasks. These features are then usable in an unsupervised clustering method within operational model 204 to group individually identified emitters 106 as actually being an individual emitter 106 and/or group of emitters 106.

Regardless of whether operational model(s) 204 assign descriptors to different signal 108 sources or associate such sources with specific emitters 106, operational model(s) 204 can also classify each emitter 106 and/or signal(s) 108 therefrom as being from a friendly or non-friendly radar network. Operational model(s) 204 can also classify the friendly or non-friendly networks according to various additional sub-types. At a high level, operational model(s) 204 may classify each emitter 106 and/or signal 108 as friendly (i.e., radar negation not required) or non-friendly (i.e., some level of radar negation is required). Analyzing a radar or radar networks may further include additional characterizations that include, among other things, one or more of the following for each emitter 106 and/or signal 108: whether the associated network is ground-based or airborne; whether it is possible to localize the emitted signals from the radar using coordination between agents 102; the degree of confidence and accuracy to which localization of emitters 106 and/or their signals 108 may be implemented; whether the associated radar network is analog or a software defined radio (SDR); whether the signals 108 emitted move through various frequencies within the EM spectrum (and which frequencies it uses); and/or whether the signal(s) 108 is/are from an emitter 106 that provides a cognitive radio (i.e., a computer-assisted radio emitter capable of actively changing its output frequencies and/or other characteristics), and if so, what behaviors (e.g., sensing and avoiding) appear to be implemented via signal(s) 108. Subclassifying each emitter 106, signal 108, and/or associated network may enable creating more informed and precise maneuvers 208 for implementations, thereby further concealing or protecting agents 102 in environment 100.

Once each emitter 106, signal 108, and/or associated radar network is identified (and, optionally, subclassified as discussed herein), RL module(s) 202 may use this identifying information to create a maneuver 208 for implementation via autonomous agent(s) 102. Maneuver(s) 208 may only be created in the case where a particular emitter 106, signal 108, and/or network is considered “non-friendly.” Maneuver(s) 208 in some cases may simply cause agent(s) 102 to move to another location and thus evade the range of emitter(s) 106 and/or signal(s) 108. Maneuver(s) 208 also may affect intercommunication between agent(s) 102. For instance, some maneuver(s) 208 may cause agent(s) 102 and/or other agent(s) 102 in the same team to transmit RF signals in a standalone or coordinated fashion to disrupt or avoid emitter(s) 106 and/or signal(s) 108. Autonomous agent(s) 102 thus include hardware for physically implementing maneuver(s) 208, e.g., by generating RF signals to jam non-friendly networks, track data corruption, etc.

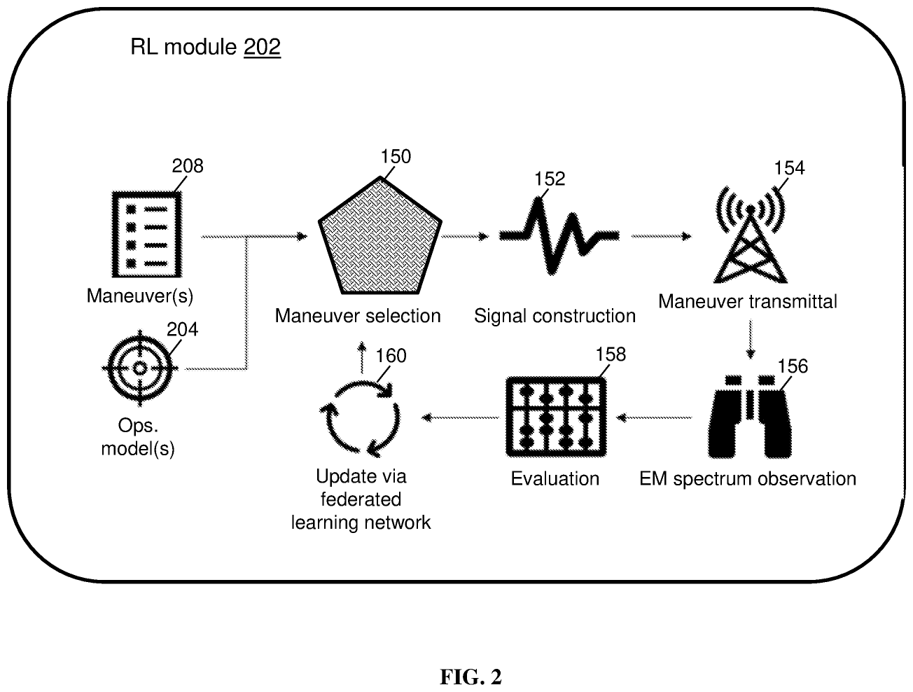

FIG. 2 depicts an expanded schematic diagram of example subcomponents for implementing maneuver(s) 208 in agent(s) 102 based on operational model(s) 204. RL module 202 may provide a combination of machine learning and other radar negation tools that may receive operational model(s) 204 as an input, together with a listing of existing maneuver(s) 208 (if any are available) each providing a possible way to counteract particular non-friendly networks. RL module 202 operates by reference to emitter 106 and/or signal profiles 108 for classified radar networks, particularly those within the generated operational models 204. RL module 202 may include a maneuver selection component 150 for choosing one or more existing maneuver(s) 208 as a candidate maneuver to be implemented for any non-friendly radar networks detected. Thereafter, RL module 204 may implement a signal construction component 150 to produce a signal for either a single agent 102 or a team of agents 102 (e.g., depending on the relevant maneuver(s) 208 selected) which could be transmitted in environment 100. In addition to the signal itself, signal construction component 152 also may assign various transmission characteristics for counteracting a particular radar network. Examples of such transmission characteristics include physical actions to perform as part of maneuver 208, modifying of tunable radio characteristics during maneuver(s) 208, etc. A maneuver transmittal component 154 of RL module 202 may transmit the updated maneuver(s) 208 to other agent(s) 102 for implementation. Once a particular maneuver 208 is performed in environment 100 (e.g., via agent(s) 102), the result of the approach is observed via an electromagnetic (EM) spectrum observation component 156. An evaluation component 158 may automatically, or with the aid of users, evaluate the effectiveness of the maneuver(s) 208 in counteracting a particular radar network. Evaluation component 158 is operable to investigate, identify, and/or store possible weaknesses such that future maneuver(s) 208 output from RL module 202 can account for them.

As various machine learning techniques benefit from larger libraries of data for training, RL module 204 may incorporate machine learning and analytic components. Machine learning components of RL module 202 iterate on, and thus improve, maneuver(s) 208 by analyzing the effectiveness of each maneuver 208 as it is implemented and use this analysis to improve performance of future maneuvers. The various components of RL module 202 can provide inputs to an updating component 160 configured for modifying federated learning network 206 (FIG. 1), and hence further training of other RL modules 202 for different agents 102 in the same team or other teams.

Maneuver selection component 150 may select from known maneuvers or may be operable to construct new maneuvers 208 for implementations, e.g., various jamming and/or phantom track tactics. For jamming approaches, maneuver selection component 150 may consider jammer behaviors such as a barrage jamming, sweep jamming, spot jamming, frequency hopping jamming, etc. Selection component 150 additionally or alternatively may consider cooperative approaches to these jamming tactics (e.g., those implemented using several autonomous agents and/or groups of autonomous agents in the radar network to be counteracted). For example, if a multi-UAV frequency hopping jamming scheme is desired (according to the input of the RF radar negation tools), maneuver selection component 150 can account for hopping sequences that are substantially identical across the team of agents 102 to achieve a power requirement or entirely non-colliding in the frequency domain to achieve a better jamming rate across the spectrum. In the case of phantom track techniques, maneuver selection component 150 may consider or create coordinated maneuvers of multiple agents 102 within environment 100 to hold a trajectory and replicate signal(s) 108 to produce a false track at a distance between an agent's 102 current position, distance, etc., and the maximum range of the radar network to be counteracted. Accordingly, maneuver(s) 208 for such approaches may include a signal specification and physical movements specified for implementations via agent(s) 102 to yield a desired result.

Referring to FIGS. 1 and 2 together, multiple RL modules 202 may cooperate within federated learning network 206 to further improve the effectiveness of maneuvers 208 to be implemented through agent(s) 102. Federated machine learning may include using multiple distributed learning processes (e.g., individual RL modules 202 each operating in a respective agent 102) working together with operational models 204 to complete an overarching task. Federated learning network 206 may replicate RL modules 202 at each agent 102 to execute particular tasks. Each agent 102 and computing device 200 within federated learning network 206 may generate and update operational models 204 locally and subsequently share the model with one or more other agents 102 in federated learning network 206. Federated learning network 206 can thus operate in a distributed fashion in contrast to centralized approaches that require that any local updates be communicated back to a central model server, which then redistributes the updated model across the network of autonomous agents. Federated learning network 206 can therefore take less time to update all affiliated agent(s) 102 in environment 100 than would a centralized approach.

Federated learning network 206 allows model updates and/or maneuvers 208 to be shared with one or more other agents 102 and passed in multiple hops through a team and/or to other teams. Any updates made to the behavior of an individual behavior 102 may be circulated through other agents 100 in a distributed manner without direct communications directly to and/or between agents 102 from a central node of federated learning network 206. These properties of federated learning network 206 allow for each agent 102 (or other network nodes) to update their maneuver(s) 208 and/or related data continuously based on new information, e.g., by sending other emitters 106, signals 108, etc., via sensors 110 and updating the learnable parameters of maneuver(s) 208 of RL module 204.

Federated learning network 206, when implemented together with operational model 204 of computing device(s) 200, provide federated reinforcement learning for operations in environments 100 with emitters 106 and signals 108 from other radar networks. Embodiments of the disclosure provide systems and methods to provide multi-agent reinforcement learning algorithms with asynchronous and distributed policy updates. Reinforcement learning assumes that none of the data (states and actions) are shared between peers in the network, but rather only updates to a global function approximator. Global function approximator components are not required in embodiments of the disclosure. Thus, the methods and systems described herein provide a low communication overhead for individual updates, thereby saving bandwidth for other communications between agents 102 and/or users 104 and enabling updates in dynamic and/or non-friendly environments.

As agent(s) 102 receive feedback about mission performance via sensor(s) 110 and/or analysis within RL module 202, agent(s) 102 may update one or more of operational models 204 to increase efficacy. Accordingly, in a swarm of agents 102, the agents 102 may learn information about the electromagnetic environment within environment 100 and may communicate this information back to one or more other agent(s) 102 to improve efficacy of operations within other environments 100. This blending of machine learning techniques allows agents 102 to update their policies according to the specific situations arising in environment 100, in contrast to pure reinforcement learning solutions. These and other properties may be particularly desirable for agile radar network negation problems, as software defined radios allow non-friendly networks to change radar continuously.

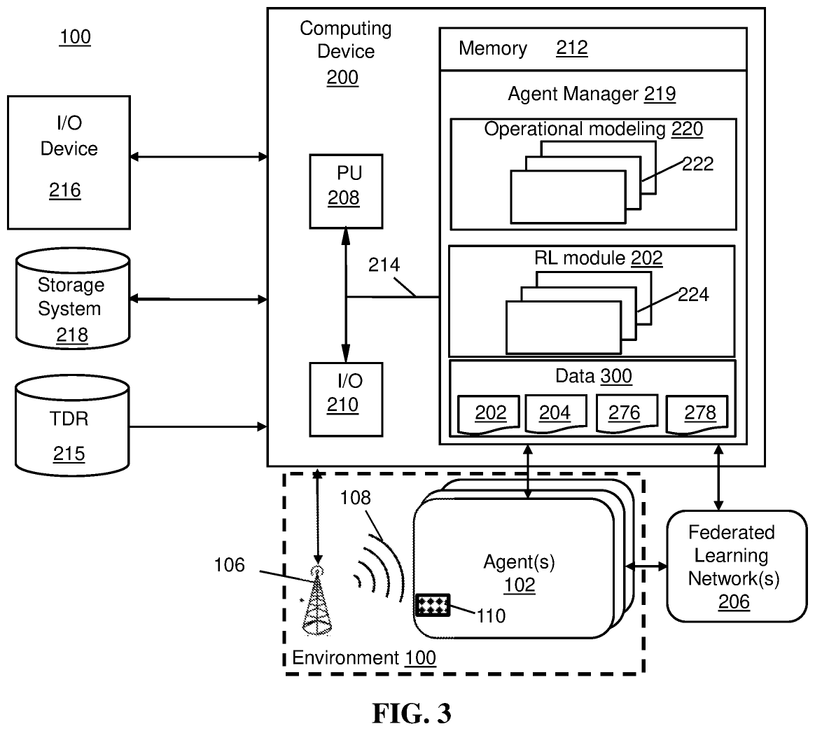

Turning to FIG. 3, embodiments of the disclosure may be implemented using a computing device 200. As discussed herein, computing device 200 may be included within and/or may be in communication with agent(s) 102. Computing device 200 thus may be integrated into wireless agent(s) 102 and/or other components described herein (e.g., various devices in communication with agent(s) 102) or may be an independent component connected to one or more devices within a team of agent(s) 102 operating within environment 100. Computing device 200 is shown by example as being connected to multiple agent(s) 102. Computing device 200 may include a processor unit (PU) 208, an input/output (I/O) interface 210, a memory 212, and a bus 214. Further, computing device 200 is shown in communication with an external I/O device 216, a storage system 218 and a training data repository (TDR) 215. External I/O device 216 may be embodied as any component for allowing user interaction with computing device 200. Memory 212 may implement an agent manager 219, included wholly or partially within memory 212 of computing device 200, which in turn may represent at least a portion of one agent 102. Agent manager 219, as discussed herein, may be configured to characterize any detected radar networks as friendly or non-friendly, generate maneuvers 208 based on the radar network being friendly or non-friendly, and instruct agent(s) 102 to perform maneuver(s) 208. Agent manager 219 can execute operational modeling program 220, which in turn can include various modules 222, e.g., one or more software components configured to perform different actions, including without limitation: a calculator, a determinator, a comparator, etc. Similarly, RL module 202 may have its own modules 224 for implementing various functions, e.g., machine learning operations. Modules 224 of RL module 202 may include any of the example subcomponents discussed herein regarding FIG. 2. Modules 222, 224 can implement various techniques to model radar networks within environment 100, classify such networks as being friendly or non-friendly, and/or generate maneuver(s) 208 to be performed as discussed herein. As shown, computing device 200 may be in communication with other agents 102 (or may be implemented on one or more of agents 102) for sending and/or receiving various forms of data to implement the functions of agent manager 219. Thus, computing device 200 in some cases may operate as a part of each agent 102, while in other cases the same computing device 200 may be connected to or included within an intermediate component (e.g., a base station (not shown)) between two or more agents 102.

Modules 222, 224 of agent manager 219 can use calculations, look up tables, and similar tools stored in memory 212 for processing, analyzing, and operating on data to perform their respective functions. In general, PU 208 can execute computer program code, such as operational modeling program 220 which can be stored in memory 212 and/or storage system 218. While executing computer program code, PU 208 can read and/or write data to or from memory 212, storage system 218, and/or I/O interface 210. Bus 214 can provide a communications link between each of the components in computing device 200. I/O device 216 can comprise any device that enables a user to interact with computing device 200 or any device that enables computing device 200 to communicate with the equipment described herein and/or other computing devices. I/O device 216 (including but not limited to keyboards, displays, pointing devices, etc.) can be coupled to agent(s) 102/computing device 200 either directly or through intervening I/O controllers (not shown).

Memory 212 can include a cache of data 300 organized for reference by agent manager 219. As discussed elsewhere herein, computing device 200 can send, receive, and/or rely various types of data 300, including metadata pertaining to other agents 102. Data 300 thus may be classified into multiple fields and, where desired, sub-fields within each field of data 300. Data 300 may be provided to and/or from agent 102, e.g., via I/O device 216 and/or other physical or wireless data couplings. To exchange data between multiple agents 102, computer system 200 may be communicatively connected to other communication features of agent 102 (I/O component 210 and/or I/O device 216). In some cases, these communication features may also be contained within memory 212 of computer system 200.

Data 300, as noted, can optionally be organized into a group of fields. In some cases, data 300 may include various fields for cataloguing operational models 204 and/or maneuvers as they are processed by and/or output from RL module 202 and/or operational modeling program 220. Data 300 further may include initial operating models 276 (i.e., previously generated and/or other referenced operational models used as inputs to operational modeling program 220) and/or extracted signal profiles 278 produced from implementing methods of the disclosure discussed herein. One or more fields of data 300 further may be catalogued within TDR 134 and/or storage system 218. Each type of data 300, however embodied, may be accessible to operational modeling program 220, which in turn may operate as a sub-program within agent manager 219. Data 300 may be mixed and parsed using operational modeling program 220 as it interfaces with a local static database, e.g., via the internet, to store and/or retrieve relevant data from other operating settings, e.g., other environments 100 with different teams of agents 102. Operational modeling program 220 thus may output operational model(s) 204 to a user 104 and/or RL module 202 via networks within environment 100 and/or via other types of connections.

Computing device 200, and/or agent(s) 102 which include computing device 200 thereon, may comprise any general purpose computing article of manufacture for executing computer program code installed by a user (e.g., a personal computer, server, handheld device, etc.). However, it is understood that computing device 200 is only representative of various possible equivalent computing devices that may perform the various process steps of the disclosure. To this extent, in other embodiments, computing device 200 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. In one embodiment, computing device 200 may include a program product stored on a computer readable storage device, which can be operative to perform any part of the various operational methodologies discussed herein.

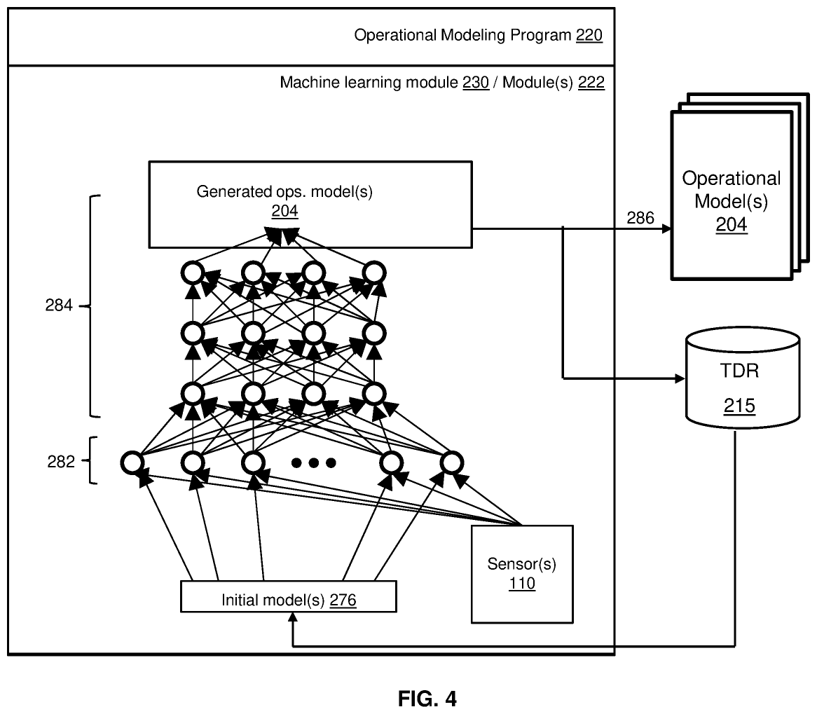

Referring to FIGS. 3 and 4, various functions of operational modeling program 220 may be implemented via machine learning module 230 (which may be included within and/or otherwise in cooperation with modules 222), e.g., any mathematical or algorithmic object capable of estimating an unknown function. A neural network is one example of a component that may be implemented as, or within, machine learning module 230. Machine learning module 230 is shown via a schematic diagram to further illustrate processes for generating operational model(s) 202 according to the disclosure. Machine learning module 230 can relate one or more input variables (e.g., one or more initial models 276 contained within, e.g., a library of training data such as TDR 215?) and incoming measurements from sensor(s) 110 within environment 100 to generate operational model 202 including, e.g., extracted signal(s) 108 and/or corresponding emitter(s) 106 within environment 100. Initial model(s) 276 may represent initial (e.g., predicted or previously generated models) of a particular environment 100 for modeling any radar networks present within environment 100. Initial model(s) 276, in some cases, may be produced from past instances of implementing methods described herein with agent(s) 102 therein.

A layer of inputs 282 includes, e.g., input(s) provided via agent(s) 102, sensor(s) 110, and/or other information transmitted to operational modeling program 220 via I/O interface 210 and/or device 216. Inputs 282 can together define multiple nodes. Each node and respective input 282 may be connected to other nodes in a hidden layer 284, which represents a group of mathematical functions. In embodiments of the present disclosure, inputs 282 can include, e.g., initial model(s) 276 for relating various inputs to detected radar signals and/or emitters. Each node of hidden layer 284 can include a corresponding weight representing a factor or other mathematical adjustment for converting input variables into output variables. Machine learning module 230 may receive data from sensor(s) 110 for immediate processing as part of the layer of input(s) 282. However, it is understood that other input(s) from agent(s) 102 and/or initial model(s) 276 also may additionally or alternatively be included in hidden layer 284 in other implementations. In embodiments of the disclosure, output 286 from machine learning module 230 can include a newly generated operational model 204 that may be classified as friendly or non-friendly within the processing structure of the machine learning network, and/or may be classified externally by other modules 222.

Machine learning module 230 may include, or take the form of, any conceivable machine learning system, and examples of such systems are described herein. In one scenario, machine learning module 230 may include or take the form of an artificial neural network (ANN), and more specifically can include one or more subclassifications of ANN architectures (e.g., a fully connected neural network, convolutional neural network, recurrent neural network, and/or combinations of these examples and/or other types of artificial neural networks), whether currently known or later developed.

With continued reference to FIGS. 3 and 4, the operation of machine learning module 230 is discussed in further detail. Machine learning module 230 may assist agent manager 219 in identifying and characterizing radar networks of environment 100 based on emitters 106 and/or signals 108. Machine learning module 230 may, for example, assist agent manager 219 by using previous data for the same environment or similar environments 100 with new, incoming data from sensor(s) 110 to update and verify the current status of emitters 106 and/or signals 108 in environment 100. Machine learning module 230, in some cases, may provide a deep learning framework by actively seeking to reduce the dimensionality of vector quantities by extracting and further analyzing extracted profiles for emitters 106 and/or signals 108 for environment 100 and feeding these profiles into a classifying sub-module within machine learning module 230.

During operation, machine learning module 230 may extract certain patterns of detected signals 108 for radar networks within environment 100, hence allowing isolation of specific communications signals and/or channels. Machine learning module 230 may train and evaluate models using a variety of performance metrics. Such metrics may include, e.g., true positives (TP), true negatives (TN), false positives (FP), and false negatives (FN). Operational profiles 202 each may classify radar network(s) within environment(s) 100 as friendly or non-friendly, and in some cases, there may be subclassifications within these categories. Operational model(s) 204 can be stored in memory 212, TDR 215, or elsewhere and provided as inputs to RL module 202 for generating maneuver(s) 208.

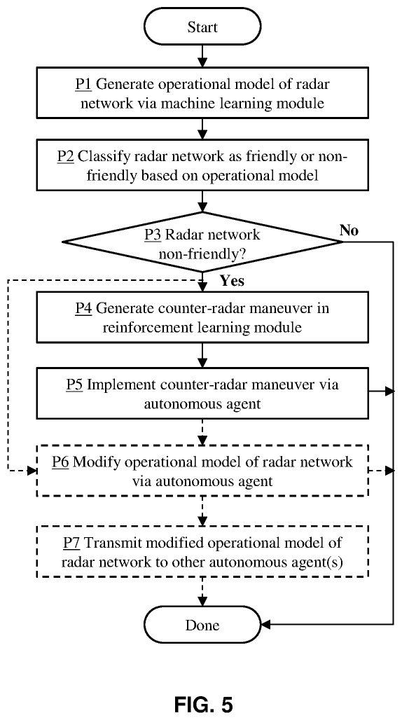

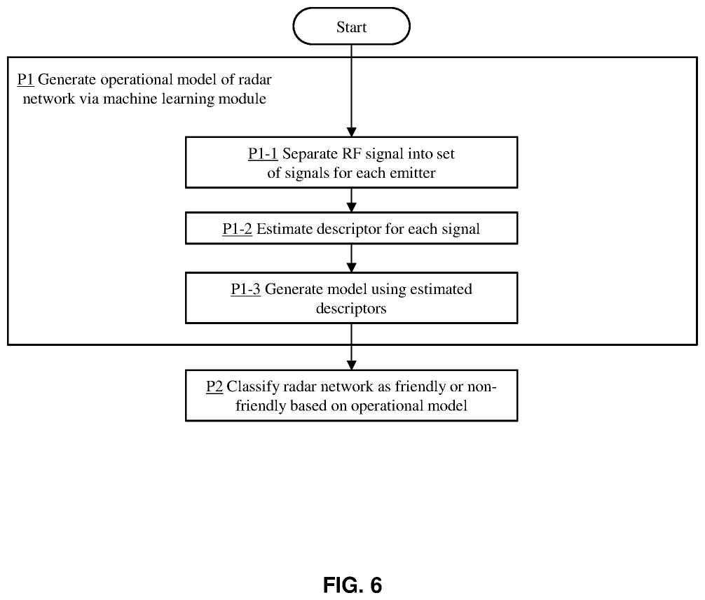

Referring to FIGS. 3-5, in which FIG. 5 provides an example of an operational methodology according to the disclosure, various processes implemented in methods of the disclosure are discussed. In process P1, operational modeling program 220 of agent manager 219 may generate operational model(s) 204 of radar networks within environment 100, e.g., based on incoming data from sensor(s) 110 and/or previously generated operational models stored in memory (e.g., as initial models 276). Various example optional sub-processes for process P1 are shown in FIG. 6 and discussed in detail elsewhere herein. Continued processing may include process P2 of classifying one or more radar networks in environment 100 as friendly or non-friendly. The classifying in process P2 may be implemented as a sub-process of generating operational model(s) 204, via other modules 222 of operational modeling program 220, and/or by interaction with one or more users 104 of agent(s) 102.

Methods of the disclosure may include, at process P3, determining whether processes occur based on whether one or more radar networks in environment 100 are non-friendly. In the case where all radar networks in environment 100 are friendly (i.e., “No” at process P3), the method may conclude (“Done”) and optionally may repeat after a predetermined amount of time and/or one or more changes in environment 100. In the case where at least one radar network in environment 100 is non-friendly (i.e., “Yes” at process P3), further processing may be implemented to counteract any non-friendly radar networks by implementing maneuver(s) 208 with autonomous agent(s) 102. In process P4, RL module 202 of agent manager 219 may generate one or more maneuver(s) 208 (e.g., avoidance, jamming, and/or other actions involving physical movement of agent(s) 102 and/or transmitting of signals) to be implemented with agent(s) 102. The generating of maneuver(s) 208 may be implemented via the processing scheme shown in FIG. 3 and discussed elsewhere herein, and/or by other forms of federated machine learning. Thereafter, process P5 may include causing agent(s) 102 to implement the generated maneuver(s) 208 by causing physical hardware (e.g., propulsion devices, radio transmitters, etc.) of agent(s) 102 to perform the generated maneuver(s). The method then may conclude (“Done”) once maneuver(s) 208 is/are implemented or may be repeated after a predetermined time has elapsed and/or changes in environment 100 occur (e.g., agent(s) 102 move to a new environment, new emitters 106 and/or signals 108 are detected, etc.).

Methods of the disclosure optionally may include other process steps, e.g., to further expand on various machine learning features. In process P6, modules 222 of operational modeling program 220 may modify one or more other operational model(s) 204 via autonomous agent 102 based on the operational model generated in process P1. Process P6 may be implemented regardless of whether operational model 204 indicates the radar network(s) is/are friendly or non-friendly in process P3. In process P7, agent management program 219 may cause agent(s) 102 to transmit these modified operational model(s) 204 to other agent(s) 102 in the same environment 100 and/or different environments. These modified operational models may be submitted as inputs to another operational modeling program 220 to provide additional data for machine learning in other, similar settings.

Referring to FIGS. 3, 4, and 6, process P1 may include one or more sub-processes for generating operational model 204 (e.g., via machine learning module 230). In process P1-1, modules 222 may separate incoming signal(s) 108 into a set of signals for each emitter 106. In process P1-2, modules 222 can estimate one or more descriptors for each signal in the set (e.g., a bandwidth, a modulation, a pulse width discriminator, or a pulse repetition interval for the respective emitter for waveforms separated in process P1-1) as discussed elsewhere herein. Process P1-3 may include machine learning module 230 generating operational model 204 using each of the variously estimated descriptors (e.g., via layer(s) 284), rather than attempting to model all radar signals in environment 100 collectively. The method may then continue to process P2 as discussed elsewhere herein.

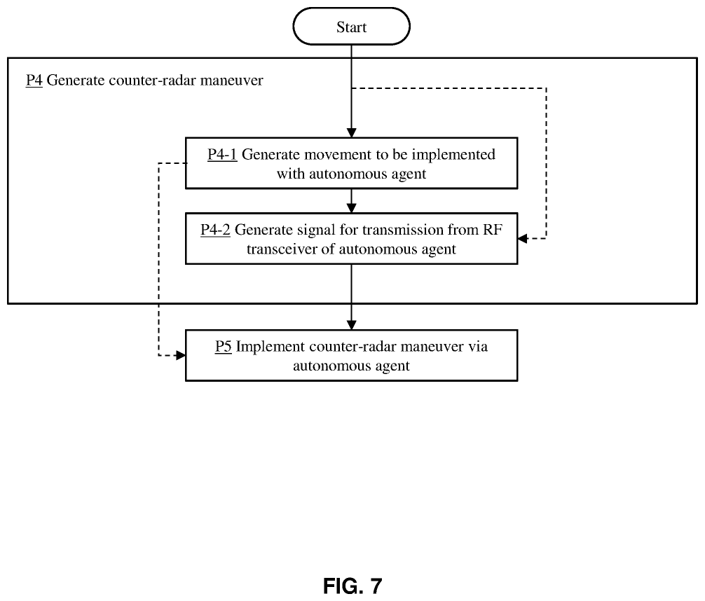

Referring to FIGS. 3, 4, and 7, process P4 of generating maneuver(s) 208 also may include various optional sub-processes. As discussed herein, maneuver(s) 208 may be a hybrid of movement and/or signal generation actions implemented via agent(s) 102, or they may include only one of these types of action in certain environment(s) 100 and/or situations. Process P4-1 may include RL module(s) 202 generating a movement to be implemented in agent(s) 102, e.g., moving to a location in environment 100 outside the detectable range of emitter(s) 106 and/or signal(s) 108. Process P4-2 may include RL module(s) 202 generating a signal for transmission via agent(s) 102, e.g., transmitting a jamming signal. The signal(s) generated in process P4-2 may be configured for implementation using only one agent 102 and/or multiple agents 102. Whether either or both processes P4-1, P4-2 are implemented may be derived from the specific operational model(s) 204 generated in other phases of processing. In any case, process P5 of implementing the generated maneuver(s) 208 may be performed after process P4 concludes.

Embodiments of the disclosure provide various technical and commercial advantages, examples of which are discussed herein. In contrast to conventional radar negation tools and/or systems, embodiments of the disclosure actively generate an operational model of a detected radar network (including, e.g., various electromagnetic characteristics) via RF sensing, signal classification, and multi-task machine learning (e.g., machine learning module 230). Embodiments of the disclosure can use this operating model to classify radar networks as friendly or non-friendly via the signals transmitted therethrough. RL modules 202 of the system, in contrast to conventional machine learning approaches, may decentralize the updating of a persistent operational model(s) 204 for all autonomous agents to allow the updated operational model(s) 204 to be transmitted between agents 102, rather than through a network base station or other central management platform.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method comprising:
generating, in a machine learning module, an operational model of a radar network within an environment, wherein an autonomous agent within the environment detects the radar network;
classifying the radar network as friendly or non-friendly based on the operational model;
generating, in a reinforcement learning module, a counter-radar maneuver based on the operational model in response to classifying the radar network as non-friendly; and
implementing the counter-radar maneuver via the autonomous agent in communication with the reinforcement learning module.

2. The method of claim 1, wherein generating the operational model of the radar network includes:
separating a detected radio frequency (RF) signal into a set of signals, each signal of the set of signals corresponding to a respective emitter; and
estimating a descriptor for each signal of the set of signals, wherein the operational model is based on the estimated descriptor for each signal of the set of signals.

3. The method of claim 2, wherein the descriptor includes one of a bandwidth, a modulation, a pulse width discriminator, or a pulse repetition interval for the respective emitter.

4. The method of claim 1, wherein the counter-radar maneuver includes:
a movement implemented with the autonomous agent; and
a signal transmitted from an RF transceiver of the autonomous agent.

5. The method of claim 1, further comprising:
modifying the operational model of the radar network; and
transmitting the operational model to another autonomous agent.

6. The method of claim 5, further comprising transmitting the modified operational model of the radar network from the autonomous agent directly to another autonomous agent.

7. The method of claim 1, wherein a remote operator controls the autonomous agent.

8. A system comprising:
a machine learning module configured to:
generate an operational model of a detected radar network within an environment, and
classify the radar network as friendly or non-friendly based on the operational model;
a reinforcement learning module in communication with the machine learning module and configured to generate a counter-radar maneuver based on the operational model in response to classifying the radar network as non-friendly; and
an autonomous agent in communication with the reinforcement learning module and configured to implement the counter-radar maneuver.

9. The system of claim 8, wherein the machine learning module is further configured to:
separate a detected radio frequency (RF) signal into a set of signals, each signal of the set of signals corresponding to a respective emitter; and
estimate a descriptor for each signal of the set of signals, wherein the operational model is based on the estimated descriptor for each signal of the set of signals.

10. The system of claim 9, wherein the descriptor includes one of a bandwidth, a modulation, a pulse width discriminator, or a pulse repetition interval for the respective emitter.

11. The system of claim 8, wherein the counter-radar maneuver includes:
a movement implemented with the autonomous agent; and
a signal transmitted from an RF transceiver of the autonomous agent.

12. The system of claim 8, wherein the autonomous agent is further configured to:
modify the operational model of the radar network; and
transmit the operational model to another autonomous agent.

13. The system of claim 8, wherein the autonomous agent is further configured to transmit the modified operational model of the radar network from the autonomous agent directly to another autonomous agent.

14. The system of claim 8, wherein a remote operator controls the autonomous agent.

15. A computer program product for control of an autonomous agent, the computer program product including a computer readable storage medium with program code for causing a computer system to perform actions including:
generating, in a machine learning module, an operational model of a radar network within an environment, wherein the autonomous agent detects the radar network;
classifying the radar network as friendly or non-friendly based on the operational model;
generating, in a reinforcement learning module, a counter-radar maneuver based on the operational model in response to classifying the radar network as non-friendly; and
implementing the counter-radar maneuver via the autonomous agent in communication with the reinforcement learning module.

16. The computer program product of claim 15, wherein generating the operational model of the radar network includes:
separating a detected radio frequency (RF) signal into a set of signals, each signal of the set of signals corresponding to a respective emitter; and
estimating a descriptor for each signal of the set of signals, wherein the operational model is based on the estimated descriptor for each signal of the set of signals.

17. The computer program product of claim 16, wherein the descriptor includes one of a bandwidth, a modulation, a pulse width discriminator, or a pulse repetition interval for the respective emitter.

18. The computer program product of claim 15, wherein the counter-radar maneuver includes:
a movement implemented with the autonomous agent; and
a signal transmitted from an RF transceiver of the autonomous agent.

19. The computer program product of claim 15, further comprising program code for modifying the operational model of the radar network via the autonomous agent.

20. The computer program product of claim 19, further comprising program code for transmitting the modified operational model of the radar network from the autonomous agent directly to another autonomous agent.
